(19) United States
(12) Patent Application Publication
(10) Pub. No.: US 2011/0233286 A1
(43) Pub. Date: Sep. 29, 2011

(54) Tepid water delivery system

(76) Inventor: John Pasquesi, Highland Park, IL (US)

(21) Appl. No.: 12/798,007

(22) Filed: Mar. 29, 2010

(51) Int. Cl. G05D 23/00

(52) U.S. Cl. 236/12.11

(57) ABSTRACT

There is disclosed a mixing valve intended for being interposed and connected to the water supply for an outdoor water spigot and incorporates a hot water supply inlet aperture for interconnecting a hot water supply line from the existing hot water source and a cold water supply aperture for interconnecting with a source for cold water, the mixing valve being positioned at a source remote from the outdoor spigot in order to provide tepid water at the outdoor water spigot location. The mixing valve may therefore be installed without reconstruction of existing walls or other structures.

### FIELD OF THE INVENTION

The present invention pertains to providing a system for bringing tepid water to an outdoor water spigot. The present invention is intended to simplify a system for allowing a mixture of hot and cold water to be supplied to an outdoor water spigot without any change or interruption in finished walls in an existing structure and without any additional penetration to the outside wall of the structure.

### BACKGROUND OF THE INVENTION

It is well known that most structures such as homes or buildings are provided with outdoor water spigots for the purpose of connecting a watering hose or other watering devices thereto. In virtually all of such instances, the outdoor water spigot is supplied by a cold water supply pipe and supplies cold water to the outdoor water spigot. In most environments, there is no need or requirement for having warmed water or tepid water being supplied to an outdoor water spigot for the reason that generally, such spigots have been used in the past for watering lawns, flower beds and the like.

However, it has been observed in many locations, with the advent of outdoor water devices such as hot tubs, pools, and the like, need the to provide warm water to an outdoor location has escalated. While some attempts have been made to provide a system which will bring hot water to an outside location via the cold water supply line, there has no practical and no easy to use solution to the problem.

For example, U.S. patent publication no. 2,002/0029415A1 is directed to an installation kit which is intended to bring hot water to an outdoor source. However, it will be observed that in order to do this, the hot water heater of the existing dwelling must be located near the outside wall where the cold water spigot is located. The system as described, will require that the homeowner connect a hot water line to the hot water tank of the dwelling. The hot water line then is brought to the outside wall wherein two spigots are provided with a Y connection such that the homeowner can control the degree of hot water by controlling two valves, one for cold and one for hot water respectively. The Y then has an outlet or spigot which is the outlet for the tepid water.

It will be observed, however, that in order to effect this installation, the installer must run a hot water line from the hot water heater of the dwelling all the way to the outside wall in order to provide both a hot and cold water spigot. In most instances, this is not possible for the reason that the hot water heater of a dwelling is usually located in a basement or the lowest level of the structure, and in many instances, if not most instances, the basement is a finished portion of the dwelling. Hence, in order to bring a hot water pipe from the hot water heater to an outside wall, one would have to remove paneling or other finished portions of a basement in order to drill the necessary holes, and run the pipe from the hot water to the outside wall. Hence, such types of installation kits or conversion kits are not practical for the homeowner since they require some major reconstruction of the basement portion of the premises in order to run the pipe from the hot water tank to the outside wall where the cold water spigot is located.

Most other patents dealing with cold outdoor water spigots are attempts at providing structures which will prevent water freeze-up in the winter time and hence provided different systems or devices for covering the outdoor water spigot. For example, U.S. Pat. No. 5,614,119 shows a system for providing an outdoor faucet with an exterior enclosure to fit over the outdoor water faucet and having a component for supplying heat within the enclosure. U.S. Pat. No. 5,694,246 attempts to provide a hot and cold water faucet assembly for outdoor use, and in enclosure for the outdoor spigot to prevent water freeze-up in the wintertime. However, it is clear that a hot water supply line has to be brought to the spigot from some source interiorly of the dwelling connected to a mixing valve in order to dispense temped water from the outdoor spigot. There is no clear indication on how the source of hot water as disclosed in the -246 patent could be conveniently utilized since if the portion of the dwelling were in the source of the hot water is located is a finished basement, one is still confronted by the same problem of trying to run a pipe from the hot water source or hot water heater, to the mixing valve which according to the system as disclosed, is positioned adjacent the outdoor water spigot. Indeed, if the interior wall behind where the water spigot is located exteriorly is a finished wall, the problems of installing the system of the -246 patent is still existent. That is, the owner of the dwelling must tear apart some finished walls in order to install the system and then repair the wall.

U.S. Pat. No. 4,644,970 shows another attempt a providing a mixing faucet for an outdoor water spigot, and shows the mixing valve located immediately behind the outdoor water spigot. A hot water supply line is provided to the mixing valve and a cold water supply is provided to the mixing valve and the mixing valve is then controlled by an exteriorly positioned control rod. Viewing the device as depicted in the -970 patent, the same problem exists as disclosed herein above. That is, if that the interior portion of the wall immediately behind the outdoor water spigot is a finished wall, the owner has the problem of running both a hot and cold water supply line to the mixing valve and that means tearing apart finished walls in order to run the pipe lines. Hence, the same problem exists with respect to the device depicted in the -970 patent.

U.S. Pat. No. 5,095,941 is directed to a sink mounted faucet which is provided with foot actuation means. The object of the invention is to provide an automatic foot actuated faucet which attaches to an existing sink which has means for controlling the temperature of the water flowing through the faucet and by actuating the foot control means, allows a predetermined amount of time for the water to flow once the petal has been depressed. As indicated in the summary of the invention, the invention includes a conventional faucet assembly which has hot and cold water manually operated valves mounted on the sink connected to a spigot but has a modified third inlet. Hence, this patent is related to sinks and foot control devices and specifically faucets intended to be mounted on an existing sink with a foot control device. The patent is not directed to nor does it have anything to do with a remote outdoor spigot which can take water from a remote hot and cold water supply in order to supply tepid water to an outdoor source.

Patent No. US 2005/0167625 United States Patent Publication, relates to a fluid control valve which includes a remotely controllable fluid controlled valve which is operated by means of a wireless control transmitter. The fluid control valve includes a solenoid mechanism inside the valve body such that valve body will operate between an open and close position in response to the activation of the receipt wireless control receiver via the wireless control transmitter. The object of the invention is to permit a user to turn off the water supply remotely so that the user does not get wet when they are relocating the sprinkler. This permits the user to move a sprinkling device without having to turn off the water supply and then move the sprinkling system. The relevance of the subject publication is that it shows the use of a wireless transmitter which controls a valve body which includes a solenoid mechanism inside the valve body to turn the valve body between ad open and closed position.

### OBJECTS AND ADVANTAGES

The object of the present invention is to provide a system for providing tepid water to an outdoor water spigot without requiring any destruction of existing walls or structures in the dwelling. The present invention is further intended to provide tepid water to an outdoor water spigot wherein no additional supply lines are required to be run to the outdoor cold water spigot thereby rendering installation practical, economical and capable of having the homeowner complete the installation on a “do-it-yourself” basis.

In conjunction with the object above, it is the principal object of the present invention to provide a system for providing tepid water to an outdoor cold water spigot by providing a mixing valve located at the source of the cold water supply line of the outdoor water spigot. The mixing valve may be located adjacent to the hot water source such that a hot water pipe may be tapped into the hot water system and connected to the mixing valve which then mixes cold and hot water, and supply the desired tepid water to the outdoor water spigot.

The present invention further provides a mixing valve which is connected to a solenoid which is driven by an electrical source, and is further provided with a signal receiving sensor panel receiving appropriate signals from a handheld remote transmitter. It may therefore be operated by remote control to turn on, off, and to provide variable positions for cold and hot water.

In conjunction with the aforegoing object, a further object of the present invention is to provide a system for providing tepid water to an outdoor water spigot by interposing a mixing valve at the remote source of the cold water supply line for the outdoor water spigot and accommodating a hot water supply line from the remote hot water source to the mixing valve, having control means in connection with the mixing valve for controlling the mixture of hot and cold water at a location remote from the outdoor water spigot such that tepid water of any desired temperature may be provided to the outdoor water spigot without the necessity of running additional pipes or mixing valves interconnecting with the outdoor spigot at its location.

Further objects and advantages of the present invention will be understood by reference to the accompanying drawings and specification set forth herein after.

### SUMMARY OF THE INVENTION

In summary, the present invention provides a system for providing tepid water to an outdoor water spigot of an existing dwelling without requiring the installation of a separate hot water line to supply and feed the cold water spigot with hot or tepid water at the source. The present invention provides a mixing valve intended to be interposed and connected to the water supply for the outdoor water spigot at its remote source, and incorporates a hot water supply inlet aperture for interconnecting a hot water supply line from the existing hot water source or hot water heater. Hence, the mixing valve is positioned at a source remote from the outdoor water spigot, and is intended to be positioned at the source of the cold water supply line for the outdoor water spigot. Further, the invention contemplates that the mixing valve be controlled by a solenoid for turning the valve, connected to a electrical source, and further incorporating a sensor panel intended to receive a signal from a remote control transmitter. The transmitter is provided with one signal for turning the unit on and off, and two other signals for turning the solenoid a clockwise direction or a counterclockwise direction in order to control the amount and degree of hot and cold water which is introduced into the supply line. In this manner, the operator may control the temperature of the outdoor water emanating from the outdoor water spigot remotely by utilizing the remote control until the desired temperature is achieved. The entire installation may be accomplished without the need of tearing apart the existing finished walls in a basement in order to achieve the supply of tepid water to an outdoor water spigot.

### BRIEF DESCRIPTION OF DRAWINGS

FIG. 1 is a schematic showing a block diagram of the system of the present invention including a mixing valve having an inlet for both hot and cold water, and an outlet for providing the mixed water into the outdoor water spigot;

FIG. 2 is a schematic diagram showing the system including the mixing valve interposed at the remote cold water supply ling, and having inlets for both hot and cold water, and an outlet for the mixed tepid water which further includes a solenoid operating the mixing valve and a signal receiving panel for receiving signals from a remote control unit for operating the system remotely.

### DETAILED DESCRIPTION OF DRAWINGS

The system of the present invention is intended to provide a simple, but economical and efficient method of providing hot water to outdoor remote spigot. Further, the present invention is intended to provide such a system which permits ease of installation in that additional pipes to run hot water to the outdoor spigot are eliminated and not required. Hence, the invention contemplates the provision of a mixing valve which would be interposed at the source of the cold water supply for supplying the outdoor water spigot which would also include a water inlet for transmitting hot water to the mixing valve. The mixing valve would be a standard mixing valve of the type generally known in the art, and which are usually operated by a manual control. By interposing the mixing valve at the remote location adjacent to where the original cold water supply pipe is located for supplying the outdoor water spigot, there is no requirement or need to tear walls apart in order to run additional pipes to the spigot.

Furthermore, it is contemplated that the source of the cold water pipe would generally be located in a room in a dwelling structure wherein the source of the hot water is also located. Hot water sources generally include hot water heaters which are generally located in the basement of a structure. Generally, the rooms which accommodate the hot water heaters are in the unfinished portions of basements and usually are located in the same place the water main is located. In such instances, the present invention contemplates installing the mixing valve direct to the cold water line and running a pipe then to the hot water heater such that the mixing valve mixing chamber can mix the desired quantity of hot and cold water, and then deliver hot water to the outdoor water spigot.

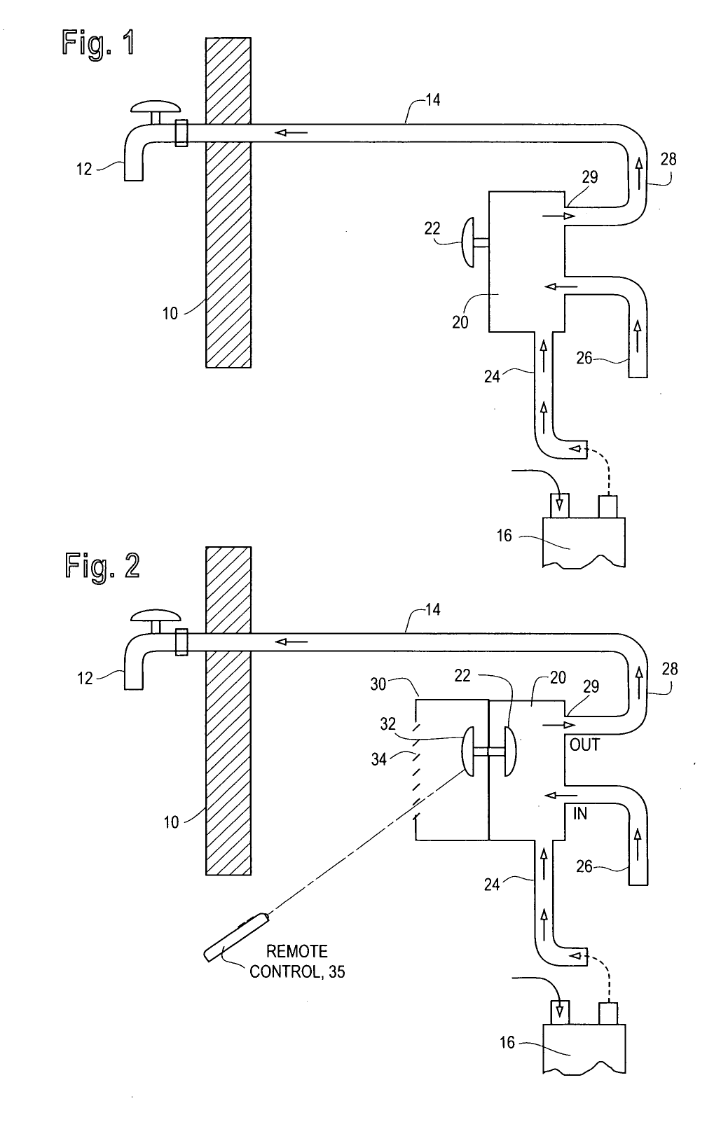

As shown in FIG. 1, the dwelling structure includes an outside wall 10 provided with an outdoor water spigot 12. The outdoor water spigot 12 is provided with a supply pipe 14 which typically eminates from a source in the dwelling adjacent to the water main (not shown). As previously indicated, such dwelling structures generally have a hot water heater 16 located in the structure, and usually in the basement premises. It is well know that the hot water heater is usually in the form of a hot water tank which is provided with a source of heat either gas or electric, and heats the water and stores it in the tank. The hot water is then supplied to the hot water pipes as required in the structure.

The present invention provides a mixing valve 20 which is constructed in the typical manner of any mixing valve. As is well know, mixing valves generally have a chamber located in the interior portion thereof, and is controlled by a manual control 22. The mixing valve is provided with a hot water supply 24 and a cold water supply 26. As is depicted in FIG. 1, it is contemplated that the cold water supply would be interrupted in order to permit the mixing valve 20 to be interposed therein. Hence, the cold water supply pipe 26 now supplies the mixing chamber of the mixing valve 20. The mixing valve also has an outlet 27 which connects to an outlet pipe 28 which now becomes the supply pipe to the outdoor water spigot 12.

From a view of FIG. 1, it is clear that the present invention contemplates that the system for providing the tepid water to the outdoor water spigot will be installed in that portion of the dwelling where the original cold water supply line is located. In most applications, the source of hot water is also located in the similar portion of the dwelling and hence, no reconstruction of the interior walls of the dwelling is required. The existing cold water supply line then becomes a tepid supply line since the mixing valve will mix the hot and cold water at the remote location then feed the mixed water into the same pipe previously used as a cold water supply.

FIG. 2 illustrates an improved version of the present invention similar numerals are used for referring to the same parts and elements as set forth previously. As shown in FIG. 2, the invention is further improved by providing the mixing valve with a solenoid control for electrically manipulating and controlling the mixing valve. A signal receiving panel encloses the solenoid and the mixing valve is constructed in the same manner as any other signal receiving sensor panel.

In referring to FIG. 2, the outside wall 10 is provided with the water spigot 12 which is fed by a cold water supply pipe 14. The mixing valve 20 is interposed at the remote source of the cold water supply pipe 14 and is also interposed into the hot water tank 16 by means of a hot water supply pipe 24. Hence, the cold water supply pipe 26 now provides cold water directly to the mixing chamber of the mixing valve 20, and the hot water supply pipe 24 provides hot water to the mixing chamber of the mixing valve 20. The mixing valve control 22 is now shown to be enclosed by means of a panel 30. The panel 30 encloses a solenoid 32 which may be wired to a electrical source for providing electrical energy thereto. The panel 30 also includes a signal receiving panel 34 which would basically have 3 inputs. The 3 inputs would include an on/off input, and a input for clockwise rotation of the mixing valve control 22, and an input for the counterclockwise rotation of the mixing valve control 22. The system is provided with a remote control unit 35 which basically transmits signals to the signal receiving sensor panel 34. It will be appreciated that when the operator presses the on/off button on the remote control unit 35, the unit 35 will send a signal to the appropriate input in the sensor panel 34 to turn the unit on. The remote control unit 35 is provided with 2 other signal transmitting buttons, one for getting a signal to cause the sensor panel to control the valve control 22 to turn in a clockwise direction and add more cold water, and another signal for causing the counterclockwise rotation of the control 22 and provide more hot water.

The convenience of the embodiment of the invention as shown in FIG. 2 is that an operator may operate the entire system externally of the dwelling by merely manipulating the remote control 35 and bring the desired level of hot water to the outdoor spigot 12. It is contemplated that the sensor receiving panel 30 which operates with a remote control unit 35 is well known in the art and is of a type similar to those provided on tv sets, radios, or other electronic equipment.

It is further contemplated that the mixing valve can take any standard construction and may be the type generally available in hardware stores or plumbing supply organizations. All of the parts to the present system are readily available and the present invention contemplates the creation of a kit to sell to the homeowner which would consist of the mixing valve/solenoid/sensor receiving panel constructed as a unit, and the necessary connectors and pipes whether solid or flexible, in order to permit the homeowner to interpose the mixing valve at the remote location required.

While there has been described at present what is considered to be the preferred embodiment of the present invention, various modifications may be made thereto and it is intended to cover in the appended claims all such obvious variations and modifications.

| | |
|---|---|
| 0 | |
| 1 | |
| 2 | |
| 3 | |
| 4 | |
| 5 | |
| 6 | |
| 7 | |
| 8 | |
| 9 | |
| 10 | Outside Wall |
| 11 | |
| 12 | Water Spigot |
| 13 | |
| 14 | Supply Pipe |
| 15 | |
| 16 | Water Heater |
| 17 | |
| 18 | |
| 19 | |
| 20 | Mixing Valve |
| 21 | |
| 22 | Manual Control |
| 23 | |
| 24 | Hot Water Supply |
| 25 | |
| 26 | Cold Water Supply |
| 27 | Mixing Valve Outlet |
| 28 | |
| 29 | |
| 30 | Panel |
| 31 | |
| 32 | Solenoid |
| 33 | |
| 34 | Signal Receiving Panel |
| 35 | Remote Control Unit |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |
| 80 | |
| 81 | |
| 82 | |
| 83 | |
| 84 | |
| 85 | |
| 86 | |
| 87 | |
| 88 | |
| 89 | |
| 90 | |
| 91 | |
| 92 | |
| 93 | |
| 94 | |
| 95 | |
| 96 | |
| 97 | |
| 98 | |
| 99 | |

1. A retrofittable system for providing tepid water to an existing remote outdoor water spigot serviced by a remote cold water supply pipe, comprising
an existing remote hot water pipe positioned adjacent to a heater for heating water,
an existing remote cold water pipe positioned at a remote location and positioned adjacent said hot water heater pipe for providing cold water to the remote outdoor water spigot.
A mixing valve being mounted and interposed between said hot and cold water pipes having inlets for hot and cold water respectively and include a mixing chamber for mixing hot and cold water to achieve a predetermined temped water temperature,
a control means associated with said mixing valve to control the relative amount of hot and cold water in order to achieve a desired water temperature,
whereby the system may be retrofitted to an existing outdoor water spigot system by interposing said mixing valve at a remote source location for hot and cold water and utilizing said control means for mixing the hot and cold water in said mixing valve mixing chamber until the desired water temperature is achieved and delivers said temped water to the existing outdoor water spigot.

2. The retrofittable water system as set forth in claim 1 above, wherein the control means comprises a manual vale for adjusting the degree of hot and cold water to be mixed in said mixing chamber.

3. The retrofittable water system as set forth in claim 1 above, wherein said control means comprises an electrically driven solenoid incorporated with said mixing valve for controlling the mixing valve to mix hot and cold water,
sensor means for receiving a remote signal and connected to said solenoid for activating and operating said solenoid in response a received signal,
and a remote control unit for transmitting predetermined signals to activate and control said solenoid via said sensor means,
whereby the temperature of the water emanating from the remote outdoor spigot may be controlled remotely by an operator manipulating the remote control unit.

4. A method for providing tepid water to a remote outdoor water spigot comprising the steps of,
providing a hot and cold water supply line remotely located from the outdoor water spigot,
providing a mixing body having a mixing chamber in said body provided with a cold water and hot water inlet and a water outlet connected to said water spigot,
connecting the hot and cold water supply lines to said mixing body,
providing said mixing body with valve means for controlling the relative amounts of cold and hot water entering said mixing chamber,
and releasing tepid water from said mixing body through said water outlet to said remote outdoor water spigot.

5. The method of claim 4 above, which further includes the steps of,
providing sensor means associated with said mixing body for sensing control signals, the sensor means be innerconnected with said valve means,
providing a remote controlled transmitter capable of transmitting signals to said sensor means,
and transmitting signals to said sensor means thereby to control the on/off function and the degree of tepid water entering into said mixing chamber of said mixing body such that tepid water is emitted from said mixing chamber to said remote water spigot.
